(19) United States
(12) Patent Application Publication
(10) Pub. No.: US 2015/0322975 A1
(43) Pub. Date: Nov. 12, 2015

(54) Control Valve for a Hydraulic System

(71) Applicant: Caterpillar Inc., Peoria, IL (US)

(72) Inventors: John Kaufman, Yorkville, IL (US); Adam Adeeb, Plainfield, IL (US); Carl McIlheran, Channahon, IL (US)

(73) Assignee: Caterpillar Inc., Peoria, IL (US)

(21) Appl. No.: 14/273,573

(22) Filed: May 9, 2014

(51) Int. Cl. F15B 11/20; F15B 13/06; E02F 9/22; B60P 1/00

(52) U.S. Cl. CPC F15B 11/205; B60P 1/006; F15B 13/06; E02F 9/2264; E02F 9/2228

(57) ABSTRACT

A hydraulic system associated with an ejector truck is configured to move an ejector plate and a rear gate. The hydraulic system may cause the rear gate to begin moving before the ejector plate. As well, the hydraulic system may reduce the delay in initiating the movement of the ejector plate and the rear gate, and increase the moving speed of both the ejector plate from the retracted position to the extended position and the rear gate from the closed position to the open position.

### TECHNICAL FIELD

This disclosure relates generally to articulated trucks having hydraulic systems and more particularly, to articulated trucks having hydraulic systems operating ejectors and associated closures.

### BACKGROUND

Trucks are used in various operations to move material held in a receptacle associated with the truck, such as dirt and rock, from one point to another. One such machine used for moving material, is an ejector type truck. Ejector type trucks do not elevate the receptacle, or bed, to unload material. Instead, a hydraulic ejector cylinder, or cylinders, urges an ejector plate (ejector) between a front and a rear of the receptacle. As the ejector plate moves from the front to the rear of the receptacle, material is ejected out of the receptacle. The material is held in the receptacle by a controlled closure in the form of a rear gate. Because the receptacle is not raised, the center of gravity is not substantially elevated as the material is ejected. Therefore, the stability of the ejector type truck is not substantially decreased as the material is ejected. In addition, the receptacle is not raised so as to interfere with overhead obstacles such as trees, power lines, and the like.

Moreover, the rate that the material is ejected from the rear of the ejector type truck may be controlled, making it possible to more evenly distribute the material over a large area thereby reducing the need to employ a bulldozer to spread the material. Additionally, the ejector type truck may also increase efficiency of the operation by moving more material per trip.

Furthermore, the receptacle of the ejector type truck includes a rear gate (closure) which prevents material from exiting the receptacle prior to the ejector plate pushing the material out of the rear of the receptacle. The rear gate is moved between a closed position which prevents material from exiting the receptacle and an open position which allows material to exit the receptacle by a hydraulic rear gate cylinder. An example of an ejector type work machine is disclosed in U.S. Publication No. 2005/105993A1, which discloses a regenerative circuit 200 that includes regenerative line 202 that connects the retract side of the hydraulic cylinder 20 to extend line 90 through a pressure operated check valve 204 and a check valve 206. The check valve 206 only allows flow in one direction in this line, i.e. from the retract side of the cylinder to the extend side (to help prevent the cylinder from drifting open unintentionally). In one form, pressure operated check valve 204 is a pressure to open check valve that opens based on a pilot pressure signal from extend line 90 through pilot line 208. In simple terms, the extend line 90 (that goes to the extend side of the cylinder) is connected with the retract line 92 (that goes to the retract side of the cylinder) through a regenerative line 202 and pressure operated check valve 204. When the cylinder is extending, oil comes from the retract side of the cylinder (that would normally flow back to tank) and flows into the extend side of the cylinder through regenerative circuit 200.

A drawback to prior art ejector type trucks is that the control of the rear gate of the hydraulic ejector cylinder is unreliable and not well coordinated. Another drawback of previous hydraulic systems is that the ejector cylinder moves slower when moving from the rear of the receptacle to the front of the receptacle. In particular, large multistage cylinders typically used as ejection cylinders utilize a large amount of hydraulic fluid that takes a substantial amount of time to move. Specifically, this large quantity of hydraulic fluid must be routed through a control valve which limits the flow of the hydraulic fluid, and causes the ejector cylinder to extend slowly.

Yet another drawback of previous hydraulic systems is that hydraulic back pressure applied to multistage ejector cylinders does not provide the proper sequencing. Moreover, the back pressure provided to the ejector cylinders slows the ejection process and is furthermore wasted during the ejection process.

### SUMMARY

In one aspect, the disclosure describes a hydraulic system that includes a first cylinder having a first end and a second end, being movable between a retracted position and an extended position, a second cylinder hydraulically coupled to the first cylinder, the second cylinder having a first end and a second end, and being movable between a retracted position and an extended position, a hydraulic pump hydraulically coupled to the first cylinder to facilitate its movement to one of its positions, and the second cylinder to facilitate its movement to one of its positions, a selector valve hydraulically coupled between the first and second ends of the first cylinder, being movable between a first configuration and a second configuration, and a sequence valve hydraulically coupled downstream of the selector valve, the sequence valve being configured to open when pressure from the second end of the first cylinder reaches a predetermined pressure, wherein, in response to the hydraulic pump providing initial flow to the first end of the first cylinder, the selector valve is in the first configuration to hydraulically couple the second end of the first cylinder to the sequence valve, and when pressure from the second end of the first cylinder reaches the predetermined pressure the sequence valve is moved to permit fluid flow from the second end of the first cylinder to the first end of the first cylinder.

In another aspect, the disclosure describes a valve assembly that includes a first ejector port and a second ejector port to be coupled to a corresponding first end and second end of a first cylinder, a first closure port and a second closure port to be coupled to a corresponding first end and a second end of a second cylinder, a third port to be coupled to one of a hydraulic pump or a lower pressure tank depending on a position of an implement valve to be coupled, the third port hydraulically coupled to the first ejector port and the second closure port, a fourth port to be coupled to the other of the hydraulic pump or the lower pressure tank, a selector valve being movable between a first position and a second position, in the first position, the selector valve is hydraulically coupled between the second ejector port and the third port and the first ejector port, and in the second position, the selector valve is hydraulically coupled between the second ejector port and the fourth port, and a sequence valve hydraulically coupled between the selector valve, the third port and the first ejector port, wherein, when the selector valve is in the first position, the sequence valve is configured to open when pressure at the second ejector port reaches a predetermined pressure to allow hydraulic fluid to move between the second ejector port and the first ejector port, when the selector valve is in its second position.

In yet another aspect, the disclosure describes a truck that includes a bed, an ejector plate coupled to the bed, the ejector plate being movable between a retracted position, such that the bed is able to receive load material, and an extended position, such that the load material is at least partially removed from the bed, a rear gate coupled to the bed, the rear gate being movable between a closed position thereby retaining the load material in the bed, and an open position thereby allowing at least a portion of the load material to be removed from the bed, a first cylinder operably connected to the ejector plate, the first cylinder having a second end and a first end, and being movable between a retracted position and an extended position, the first cylinder configured to move the ejector plate between the retracted and extended positions, a second cylinder operably connected to the rear gate and hydraulically connected to the first cylinder, the second cylinder having a second end and a first end, and being movable between a retracted position and an extended position, the second cylinder configured to move the rear gate between the closed and open positions, a hydraulic pump coupled to the first and second cylinders, a selector valve hydraulically connected to the second end of the first cylinder, being movable between a first configuration and a second configuration, and a sequence valve hydraulically connected between the selector valve and the first end of the first cylinder, wherein, in response to the hydraulic pump providing initial flow to the first end of the first cylinder to move the first cylinder to the extended position, the selector valve is in the first configuration to hydraulically couple the second end of the first cylinder to the sequence valve, and the sequence valve is configured to open when pressure from the second end of the first cylinder reaches a predetermined pressure, to permit fluid to flow from the second end of the first cylinder to the first end of the first cylinder.

### BRIEF DESCRIPTION OF THE DRAWINGS

FIG. 1 is a side view of a truck according to an aspect of the disclosure.

FIG. 2 is a fragmentary perspective view of a rear portion of a bed of the truck of FIG. 1 showing an ejector plate in a retracted position and a rear gate in a closed position.

FIG. 3 is a fragmentary perspective view similar to FIG. 2 showing the ejector plate in an extended position and the rear gate in a closed position.

FIG. 4 is a schematic representation of a control valve assembly and a hydraulic system coupled to the ejector plate and the rear gate.

FIG. 5 is a perspective view of a manifold according to one aspect of the disclosure.

FIG. 6 is a right side view of the manifold of FIG. 5.

FIG. 7 is a top view of the manifold of FIG. 5.

FIG. 8 is a front end view of the manifold of FIG. 5

FIG. 9 is a left side view of the manifold of FIG. 5.

FIG. 10 is a bottom view of the manifold of FIG. 5.

FIG. 11 is a back end view of the manifold of FIG. 5.

### DETAILED DESCRIPTION

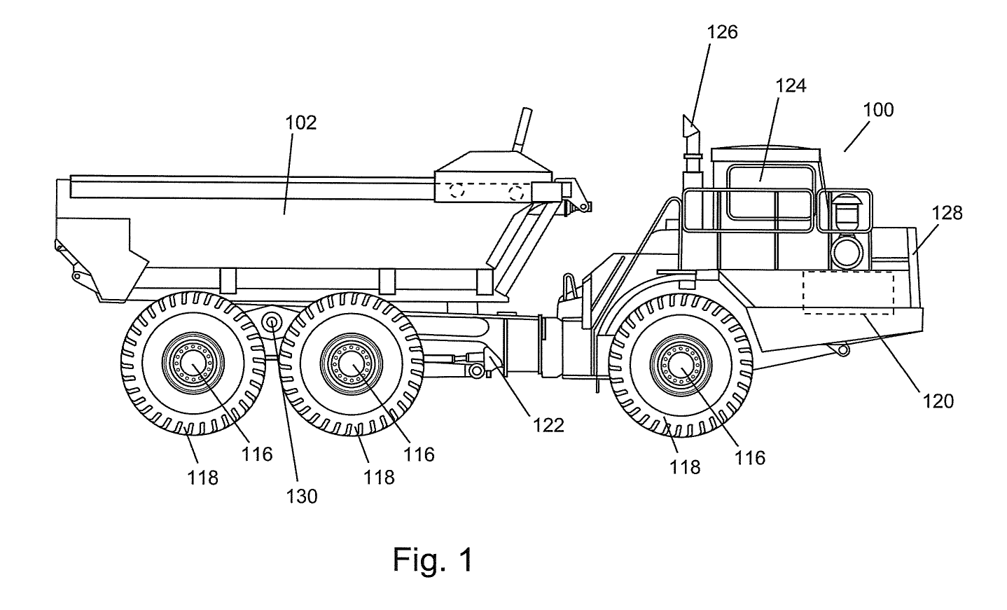

Now referring to the drawings, FIG. 1 illustrates a truck 100 or any other type of machine that performs some type of operation associated with an industry such as mining, construction, farming, transportation, or any other industry known in the art. For example, the truck 100 may be an off-highway truck, earth-moving machine, a wheel loader, excavator, dump truck, backhoe, motor grader, material handler, garbage truck, earth scraper, wheel tractor scraper, self-loading dump truck, or the like. The specific machine illustrated in FIG. 1 is an ejector articulated truck.

It should be noted that the various features described with respect to an articulated truck are merely one aspect of the disclosure. The disclosure contemplates any type of truck utilizing an ejector and having a corresponding closure. For example, a garbage truck may have a closure to maintain garbage within the garbage truck. The garbage truck may further include an ejector to eject the garbage from the garbage truck once the closure has been opened. Likewise, a wheel tractor scraper may also include an ejector having a corresponding closure. The closure being closed to maintain a load and the closure being opened to allow a load to be ejected utilizing an associated ejector.

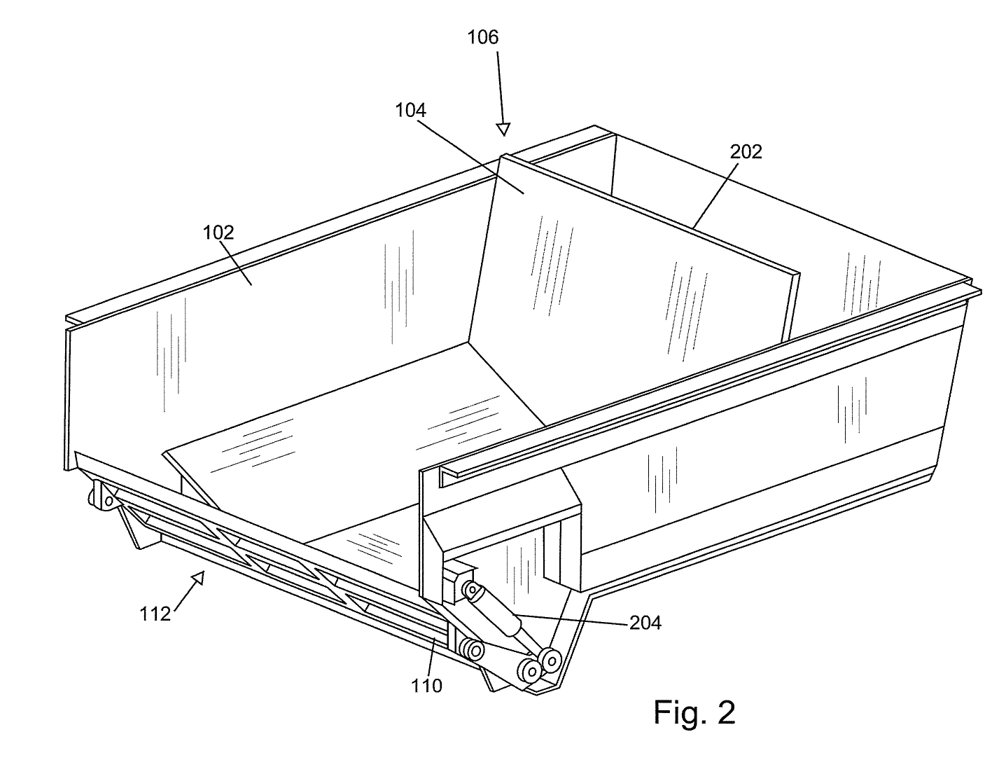

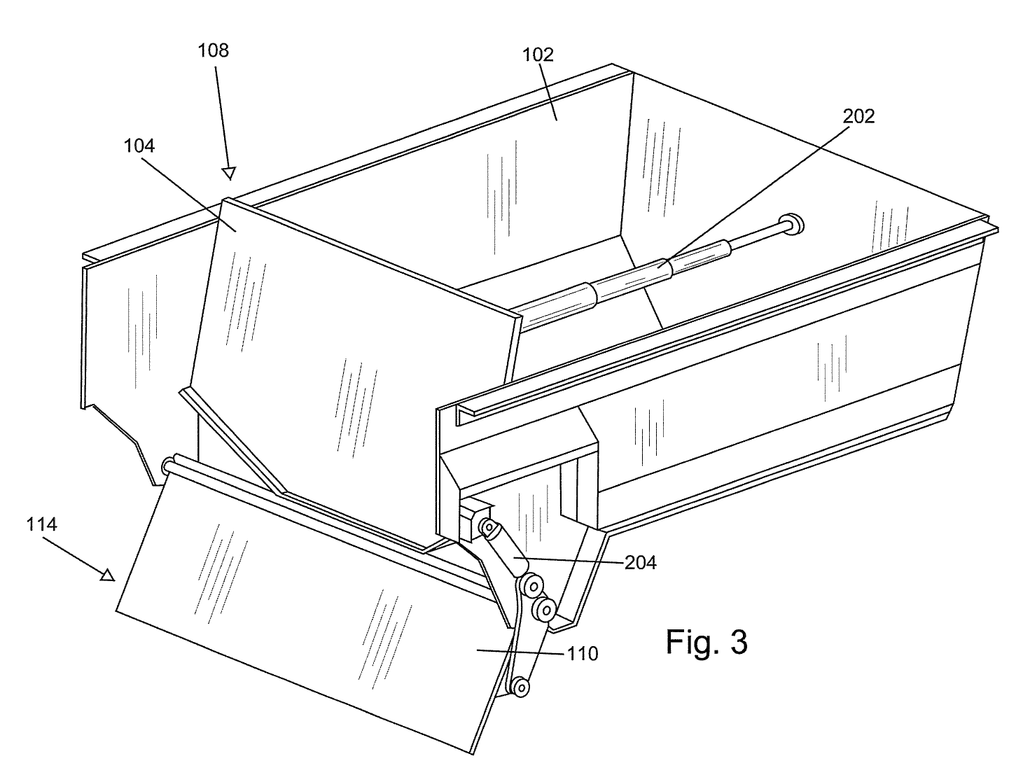

An ejector articulated truck 100 (“ejector truck”) may be a dump truck that ejects load material out a back of a bed 102. The ejector truck 100 may include an ejector plate 104 that may be movably associated with the bed 102. Specifically, the ejector truck 100 may operate by moving the ejector plate 104 from a retracted position 106, as shown in FIG. 2, to an extended position 108, as shown in FIG. 3. In the retracted position 106, the bed 102 may receive load material, and in the extended position 108, load material may be removed from the bed. The ejector articulated truck 100 may further include wheels 116, tires 118, a combustion engine 120, a transmission 122, a fuel tank, operator controls 124, an exhaust system 126, a cooling system 128, a suspension 130, and the like.

The ejector truck 100 may also include a rear gate 110 that is movably associated to the bed 102. While the ejector plate 104 is moving from the retracted position 106 to the extended position 108, the rear gate 110 may move from a closed position 112, as shown in FIG. 2, to an open position 114, as shown in FIG. 3. In the closed position 112 the load material may be generally retained in the bed 102, and in the open position 114 the load material may be ejected from the bed 102. It should be appreciated that the movement of the rear gate 110 may be independent or dependent upon the movement of the ejector plate 104. In some aspects, the rear gate 110 will begin to open before the ejector plate 104 begins to extend. However, it should also be appreciated that the rear gate 110 may begin opening before, after, or substantially at the same time as the extension of the ejector plate 104. It should be appreciated that the term “substantially” in this context means for the most part.

As shown in FIGS. 2-4, the movement of the ejector plate 104 and the rear gate 110 is realized in part by a hydraulic system 200. The hydraulic system 200 may include a first cylinder 202 having a first end 248 and a second end 250. The first cylinder 202 may be operably connected to the ejector plate 104 as shown in FIG. 3. Other arrangements are contemplated as well. In operation, the first cylinder 202 may move from a retracted position to an extended position, which correspondingly also causes the ejector plate 104 to move from the retracted position 106 to the extended position 108. In some aspects the first cylinder 202 is a telescopic multi-stage cylinder (“multi-stage cylinder”). It should be appreciated that multi-stage cylinders may include a series of cylinders and rods of progressively smaller diameters nested within each other, which may provide for a long extension from a compact retracted length, such as the travel distance required to move the ejector plate 104 from the retracted position 106 to the extended position 108. As well, the multi-stage cylinder may be double-acting, whereby either a head end or a rod end may be pressurized with hydraulic fluid to actuate the cylinder to extend or retract. However, it should be appreciated that the first cylinder 202 may be any type of cylinder configured to be hydraulically actuated.

In aspects where the first cylinder 202 is a telescopic multi-stage cylinder, it may be important to extend the larger diameter rods prior to extending smaller diameter rods. In this regard, back pressure may be applied to the smaller diameter rods to prevent their extension while allowing the larger diameter rods to extend.

The hydraulic system 200 may also include at least one second cylinder 204 hydraulically connected to the first cylinder 202 and operably connected to the rear gate 110. Similar to the first cylinder 202, the second cylinder 204 may also have a first end 252 and a second end 254. In operation, the second cylinder 204 may move from an extended position to a retracted position, which correspondingly also causes the rear gate 110 to move from the closed position 112 to the open position 114. In some aspects, the second cylinder 204 may be a single-stage cylinder that includes one cylinder and one rod. Moreover, the single-stage cylinder may be double-acting, whereby either a head end or a rod end may be pressurized with hydraulic fluid to actuate the second cylinder 204 to extend or retract. As previously discussed with regards to the movement of the rear gate 110, the movement of the second cylinder 204 from the extended position to the retracted position may begin at least a predetermined duration of time before the first cylinder 202 begins to extend. As well, it should be appreciated that the second cylinder 204 may be any type of cylinder configured to be hydraulically actuated. Moreover, another second cylinder 204 may be arranged on the opposite side of the bed 102.

With regards to the first and second cylinders 202, 204, it should be appreciated that the first ends 248, 252 may be head ends and the second ends 250, 254 may be rod ends. However, in some aspects, the first end may be the rod end and the second end may be the head end. Yet in some other aspects, the first end 248 of the first cylinder 202 may be the head end, while the first end 252 of the second cylinder 204 may be the rod end. Accordingly, the second end 250 of the first cylinder 202 may be the rod end, while the second end 254 of the second cylinder 204 may be the head end. In general, it should be appreciated that the terminology “first end” and “second end” may be used to describe any type of head end or rod end in the first and second cylinders 202, 204.

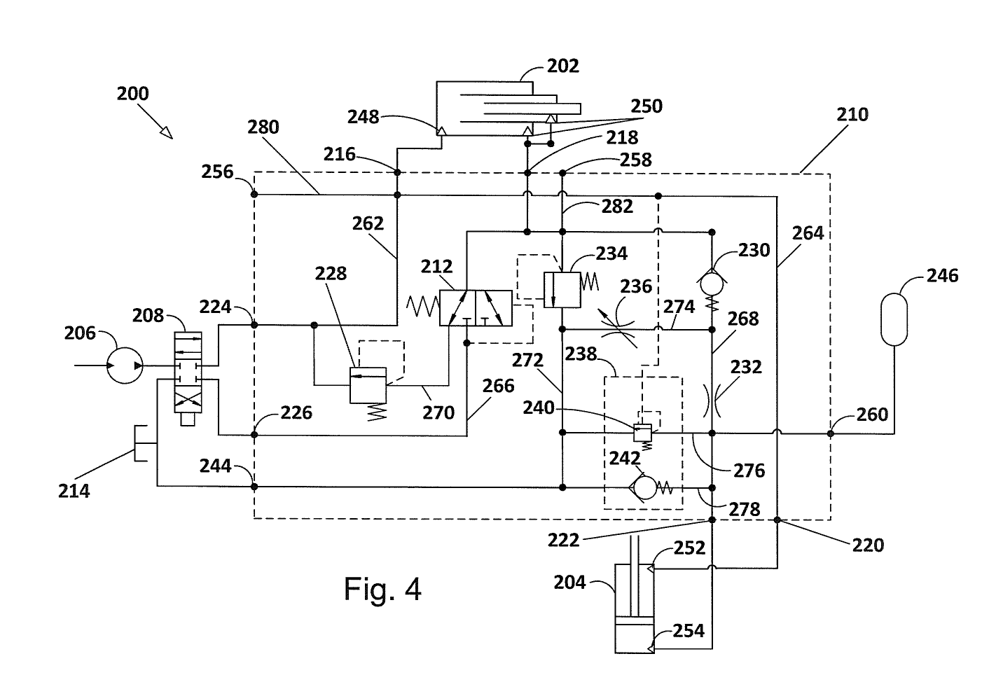

As illustrated in FIG. 4, the hydraulic system 200 may include a hydraulic pump 206, a low pressure tank 214, and an implement valve 208 configured to selectively hydraulically connect the hydraulic pump 206 and the tank 214 to a valve assembly 210.

The valve assembly 210 also may include a first ejector port 216 and a second ejector port 218 to be coupled to a corresponding first end 248 and second end 250 of a first cylinder 202, respectively. The valve assembly 210 may also include a first closure port 220 and a second closure port 222 to be coupled to a corresponding first end 252 and a second end 254 of a second cylinder 204, respectively. The first and second ejector ports 216, 218 and first and second closure ports 220, 222 may be configured to allow pressurized hydraulic fluid flow to enter or leave the corresponding first ends 248, 252 or second ends 250, 254 of the cylinders 202, 204, to thereby move the cylinders 202, 204 to the retracted or the extended position.

As well, the valve assembly 210 may include a third port 224 to be coupled to one of the hydraulic pump 206 or the main hydraulic fluid tank 214, depending on a position of the implement valve 208. The third port 224 may be hydraulically coupled to the first ejector port 216 via a conduit 262 and the first closure port 220 via conduit 264. Conduit 264 may branch off of conduit 262 within the valve assembly. The valve assembly 210 may also include a fourth port 226 to be coupled to the other of the hydraulic pump 206 or the main hydraulic fluid tank 214. The fourth port 226 may be hydraulically coupled to the second ejector port 218 via a conduit 266 and the second closure port 222 via a conduit 268. Conduit 268 may be hydraulically coupled to conduit 266 within the valve assembly. The hydraulic pump 206 may be selectively hydraulically connected to at least the first end 248 of the first cylinder 202 via conduit 262 and port 216 to facilitate its movement to the extended position 108, and the second end 254 of the second cylinder 204 via conduit 264 and port 220 to facilitate its movement to the retracted position 106.

The valve assembly 210 may also include a selector valve 212 hydraulically connected to the port 218 via conduit 266. The selector valve 212 may be hydraulically actuated to move between a first configuration and a second configuration. However, in some aspects the selector valve 212 may be actuated by a solenoid, or the like. The selector valve 212 may be hydraulically connected between the port 218 and the port 216 via a conduit 270 and portions of conduits 266 and 262. In one configuration, the selector valve 212 is a three-port, two position valve biased by a spring member in the first configuration. Signal pressure is communicated from the conduit 266 to the side opposite the spring member. When pressure in the conduit 266 is high enough to create a force greater than the spring force of the spring, the valve may move to the second configuration. It should be appreciated that the conduit may have internal passageways formed into the housing. However it is appreciated that conduit may be formed from hydraulic hosing or other means.

When the selector valve 212 is in the first configuration (as shown in FIG. 4), at least the second port 218 may be hydraulically connected to the first port 216 via an internal passageway formed in the valve 212 and portions of conduits 266, 270, and 262, while another the portion of conduit 266 leading to port 226 is blocked. A first sequence valve 228 may be included along conduit 270. The first sequence valve 228 may be configured to open when pressure from the second port 218 reaches a predetermined pressure to create a force to overcome the spring bias. When the predetermined pressure is reached, the sequence valve 228 may then open to hydraulically connect the second port 218 to the first port 216. It should be appreciated that the sequence valve 228 may be a relief valve, or any type of valve configured to open when pressure reaches a predetermined amount. In some aspects, the predetermined pressure is 100 bars. However, it should be appreciated that the predetermined pressure may be any pressure less than or greater than 100 bar.

One aspect of the operation of the first configuration is to regenerate or utilize the hydraulic fluid from the second end 250 of the first cylinder 202 into the first end 248 of the first cylinder 202. This combination of components provides the proper back pressure at the second end 250 and utilizes the additional hydraulic fluid to help extend the first cylinder 202 by applying this additional hydraulic fluid to the first end 248. Accordingly, a proper amount of back pressure is applied to the first cylinder 202 to ensure proper sequencing of the multistage cylinders and the speed of the extension of the first cylinder 202 is increased as well.

The implement valve 208 may operate in at least one of 1) a first configuration, 2) a second configuration, and 3) a third configuration. To implement the three configurations, the implement valve 208 may include three-valve portions, which may include a four-port valve portion, a four-port closed valve portion, and a four-port crossed valve portion. When the implement valve 208 is in the first configuration, the implement valve 208 may position the four-port valve portion in hydraulic communication with ports 224 and 226. In this configuration, the implement valve 208 may hydraulically connect the hydraulic pump 206 with port 216 via conduit 262 and port 224 to facilitate movement of the first cylinder to the extended position. As well, in the first configuration the implement valve 208 may hydraulically connect port 218 with the hydraulic fluid tank 214 via the selector valve 212 and port 226.

When the implement valve 208 is in the second configuration, the implement valve 208 may position the four-port crossed valve portion in hydraulic communication with ports 224 and 226. In this configuration, the implement valve 208 may hydraulically connect at least the second port 218 to the hydraulic pump 206 to facilitate movement of the first cylinder to the retracted position. Accordingly, the selector valve 212 in the second configuration may be hydraulically connected between the second ejector port 218, the fourth port 226, and the second closure port 222. When the selector valve 212 is in the second configuration, at least the second port 218 may be hydraulically connected to the fourth port 226 via an internal passageway formed in the valve 212 and portions of conduits 266, while the conduit 270 leading to port 218 is blocked. However, it should be appreciated that the selector valve 212 may be configured to hydraulically connect any component and/or port of the hydraulic system 200 and/or valve assembly 210 in any configuration. Additionally, in the second configuration the implement valve 208 connects the first port 216 through port 224 to the tank 214. Thus, the hydraulic fluid from the first end 248 may be drained to the tank 214 to allow for quick refraction of the ejector 104.

Furthermore, when the implement valve 208 is in the third configuration, the implement valve 208 may position the four-port closed valve portion in hydraulic communication with ports 224 and 226. In this third configuration, the implement valve 208 may hydraulically connect the hydraulic pump 206, the main hydraulic fluid tank 214, the first end 248 of the first cylinder 202, and the selector valve to respective closed paths on the four-port closed valve portion via ports 224 and 226.

As well, conduit 268 of the valve assembly 210 may include a one-way valve 230 hydraulically connected between the ports 226 and 222. The one-way valve 230 may be configured to allow hydraulic fluid to flow in a single direction from the port 226 to port 222. A restriction 232 may be included at conduit 268 downstream of the valve 230. The restriction 232 may be configured to restrict the flow from the one-way valve 230 to the first end 252 of the second cylinder 204. In some aspects the restriction 232 is an orifice plug. However, it should be appreciated that the restriction 232 may be any type of device configured to restrict flow.

With continued reference to FIG. 4, the valve assembly 210 may further include a second sequence valve 234 disposed along conduit 272 that hydraulically connects to conduit 268 at a portion upstream of the valve 230. The valve 234 may be hydraulically connected to the port 218, which may allow the sequence valve 234 to open when pressure from the port 218, indicative of the pressure at the second end 250 of the first cylinder 202, reaches a predetermined pressure. When pressure from the sequence valve 228 reaches the predetermined pressure, the sequence valve 228 may open to thereby hydraulically connect the second port 218 or second end 250 of the first cylinder 202 with the main hydraulic fluid tank 214 via tank port 244. It should be appreciated that the second sequence valve 234 may be a relief valve, or any type of valve configured to open when pressure reaches a predetermined amount. In some aspects, the predetermined pressure is greater than 228 bar. However, it should be appreciated that the predetermined pressure may be any pressure less than or greater than 228 bar.

The valve assembly 210 may further include a needle valve 236 hydraulically connected between conduits 272 and 268 along conduit 274 at a location downstream of the valve 234 and between the one-way valve 230 and the restriction 232. The needle valve 236 may be configured to be opened to facilitate fluid flow from the one-way valve 230 to the hydraulic fluid tank 214 via tank port 244. The needle valve 236 may be any type of valve configured to manually or automatically release pressure in a hydraulic system. Furthermore, in some aspects, the needle valve 236 may be a normally closed needle valve. In other aspects, the needle valve 236 may be a normally open needle valve. The valve 236 may be variably set and tuned depending on the system requirements. In operation, the needle valve 236 may allow operation with a “dead engine” to drain hydraulic fluid from the second cylinder 204 by allowing hydraulic fluid to flow from 254 through restriction 232, subsequently through needle valve 236, through the tank port 244 and into tank 214.

As well, the valve assembly 210 may include a load control valve 238 as shown in the dashed box. The load control valve 238 may be configured to relieve pressure at the first end of the second cylinder via port 222. Accordingly, the valve 238 may include at least one of a load control sequence valve 240 and a load control one-way valve 242. In some aspects, the load control sequence valve 240 and the load control one-way valve 242 may be coupled in parallel or in series. For instance, the valve 240 may be coupled to conduit 276 located between conduit 272 downstream of valve 234 and conduit 268 downstream of the orifice 232. The valve 242 may be coupled to conduit 278 located between conduit 272 downstream of valve 234 and conduit 268 downstream of the orifice 232, where conduit 278 is closer to port 222 than conduit 276. The load control sequence valve 240 may be a relief valve, or any type of valve configured to open when pressure reaches a predetermined load. In some aspects, the predetermined load may be a specified range that is between about 200 bar and about 210 bar. However, it should be appreciated that the predetermined load may be any pressure less than or greater than the specified range. Upon opening of the load control sequence valve 240, this may facilitate hydraulic fluid to flow through the load control valve 238 and to the tank port 244, which may drain in to the main hydraulic fluid tank 214.

The hydraulic system 200 may also include an auxiliary accumulator 246 that may be hydraulically connected to an accumulator port 260 on the valve assembly 210. The auxiliary accumulator 246 may be configured to store pressure via port 260. In this manner, the accumulator 246 may pressurize port 260 when the pressure at port 260 meets a predetermined pressure. In this manner, the accumulator 246 may be hydraulically connected between the restriction 232 and the port 222, thereby connecting to first end 252 of the second cylinder 204. In this manner the accumulator 246 may supply additional hydraulic fluid to the first end 252 of the second cylinder 204. It should be appreciated that the accumulator 246 may enable the hydraulic system to cope with varying pressure demands. As such, the hydraulic system may respond more quickly to a temporary pressure demand, as well as even out pulsations so that the first and second cylinders may extend and retract more smoothly. As well, it should be appreciated that in some aspects, the accumulator 246 may be a charge pump.

The valve assembly 210 may also include at least one port for testing hydraulic pressure within the valve assembly 210. As shown in FIG. 4, the valve assembly 210 may include an ejector head pressure test port 256 that may be hydraulically connected to the first ejector port 216 via conduit 280 and the first closure port 220 via conduit 264. The ejector head pressure test port 256 may be configured to receive a device, such as a pressure gauge, and may provide an indication of the pressure that exists between the first ejector port 216 and the first closure port 220. It should be appreciated that within the hydraulic system 200 the ejector head pressure test port 256 may be hydraulically connected to the first end 248 of the first cylinder 202 and the second end 254 of the second cylinder 204 to thereby indicate the pressure between the first end 248 of the first cylinder 202 and the second end 254 of the second cylinder 204.

As well, the valve assembly 210 may include an ejector rod pressure test port 258 that may be hydraulically connected to the second ejector port 218 via conduit 282 and 268 and the second closure port 222 via conduit 268. As such, the ejector rod pressure test port 258 may also be configured to receive a device, such as a pressure gauge, and provide an indication of the pressure that exists between the second ejector port 218 and the second closure port 222. It should be appreciated that within the hydraulic system 200 the ejector rod pressure test port 258 may be hydraulically connected to the second end 250 of the first cylinder 202 and the first end 252 of the second cylinder 204 to thereby indicate the pressure between the second end 250 of the first cylinder 202 and the first end 252 of the second cylinder 204.

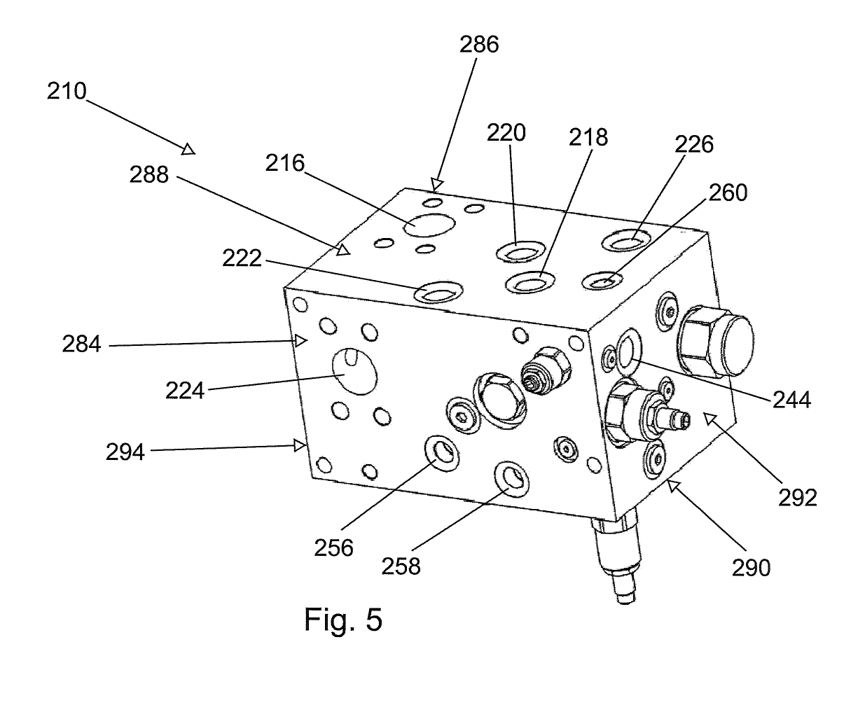

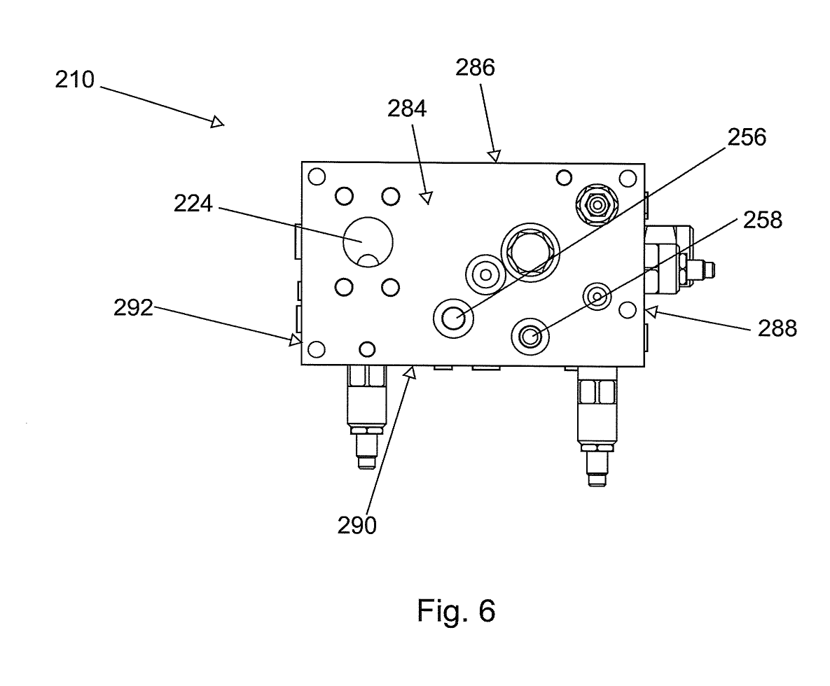

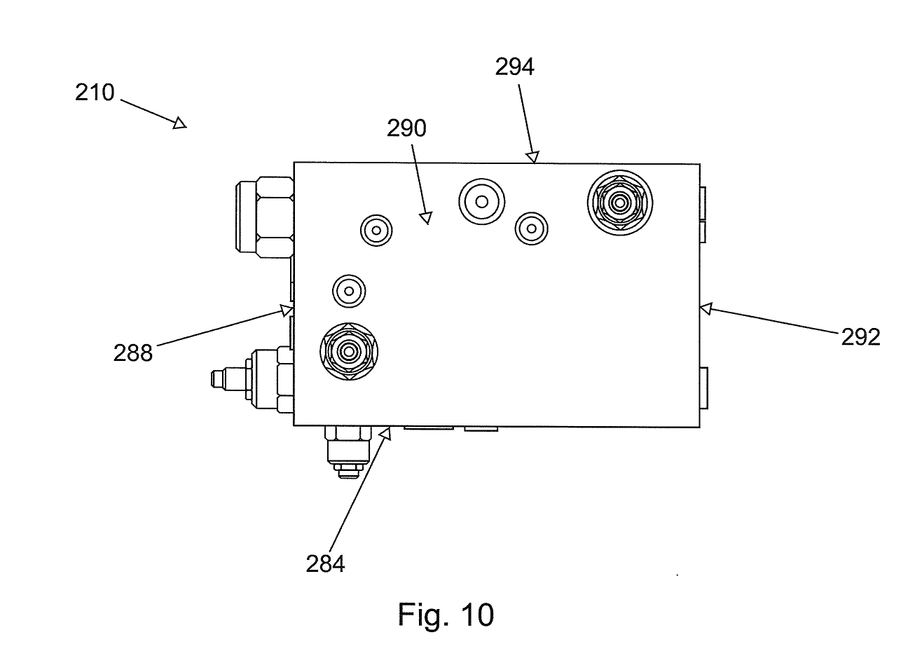

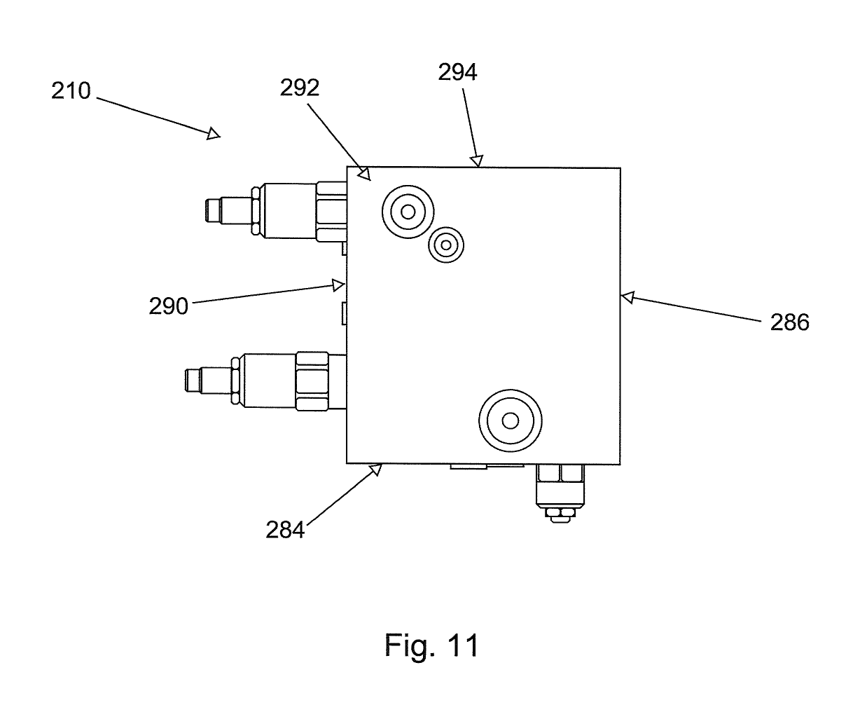

FIG. 5 is a perspective view of a valve assembly 210 according to one aspect of the disclosure. FIGS. 5-11 illustrates that the valve assembly may be a manifold having a box-like shape. With specific reference to FIGS. 5 and 6, a first side 284 of the valve assembly 210 may include access to the third port 224, the ejector head pressure test port 256 and the ejector rod pressure test port 258.

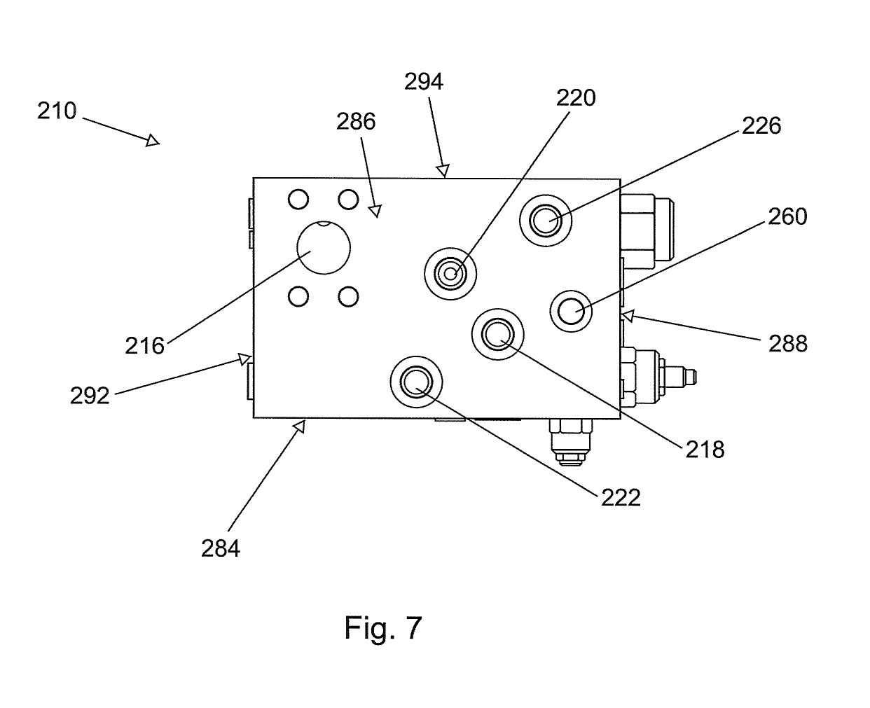

As shown in FIGS. 5 and 7, the valve assembly 210 may also define a second side 286 adjacent to the first side 284. The second side 286 may include access to the first ejector port 216, the second ejector port 218, the first closure port 220, the second closure port 222 and the fourth port 226.

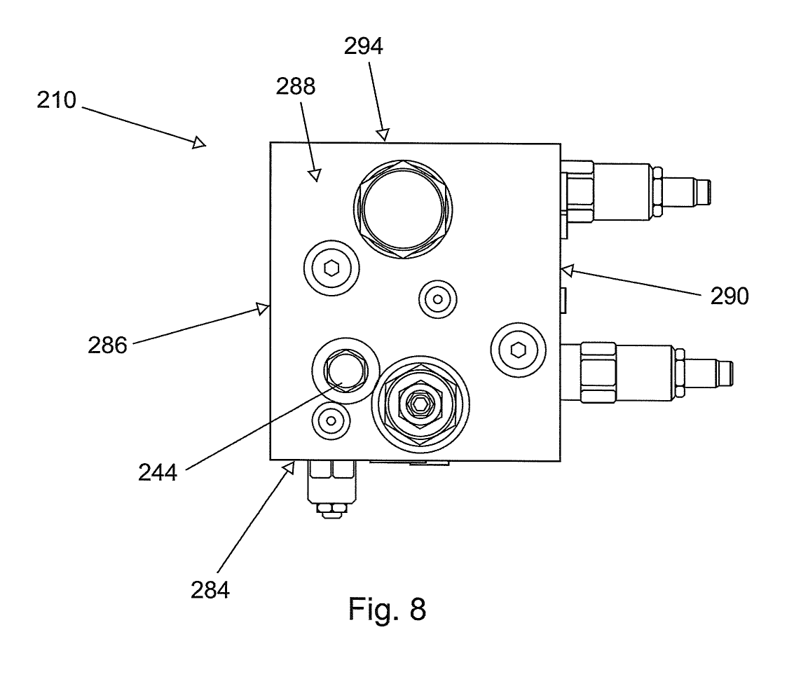

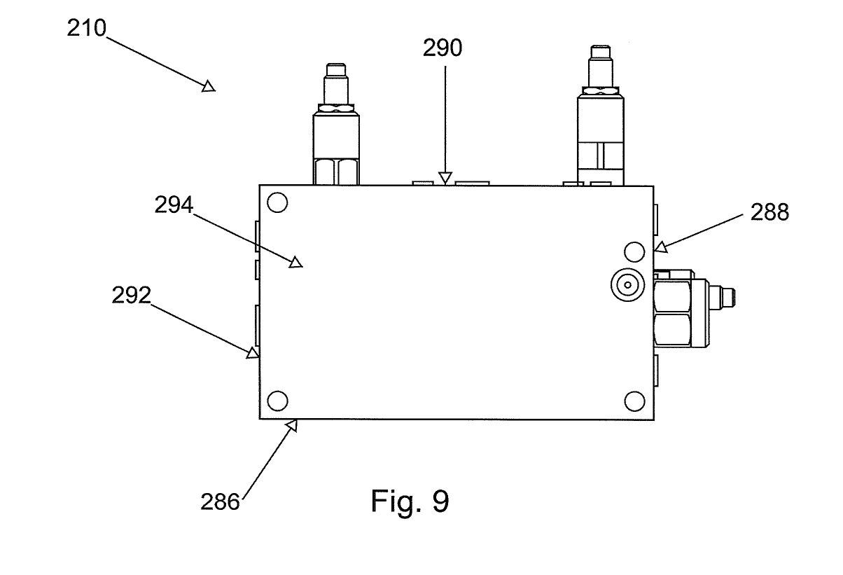

Now referring to FIGS. 5 and 8, the valve assembly 210 may also define a third side 288 that may be adjacent to the first and second sides 284, 286. The third side 288 may include access to the fifth port 244. It should be appreciated that the valve assembly 210 may be configured in any suitable arrangement with ports arranged on any side of the valve assembly 210. Moreover, FIGS. 9-11 also illustrate a sixth side 294, a fourth side 290, and a fifth side 292, respectively, of the valve assembly 210 and other components not discussed herein.

### INDUSTRIAL APPLICABILITY

The present disclosure is applicable to hydraulic systems on trucks, and more specifically to hydraulic systems on ejector trucks. Ejector trucks are configured to push load material from the bed of the truck by moving the ejector plate 104 from the retracted position 106 to the extended position 108. As part of the same operation, the rear gate 110 moves from the closed position 112 to the open position 114 to thereby allow the load material to be pushed from the bed 102. Now, referring to FIGS. 2 and 3, the rear gate 110 may begin to lower slightly after the ejector plate 104 begins to move to the extended position 108. This sequence may be coordinated in order to allow the ejector plate 104 to slightly compact the load material against the rear gate 104. It should be appreciated that this may allow the dumping of the load material to be more consistent. However it should also be appreciated that the opposite may happen, whereby the rear gate 110 may begin to open before the ejector plate 104 begins to move to the extended position 108. This may be performed in order to relieve pressure on the rear gate 110, such as pressure caused by the ejector plate 104 pushing load material against the rear gate 110. By relieving excess pressure on the rear gate 110, this may increase longevity of the hydraulic system 200. It should be appreciated that the rear gate 110 may begin to move from the closed position 112 to the open position 114 before, after, or simultaneous to beginning the movement of the ejector plate 104 from the retracted position 106 to the extended position 108.

In order to initiate movement of the rear gate 110 before movement of the ejector plate 104, back pressure may need to be applied to the first cylinder 202. For example, in some aspects the first end 248 of the first cylinder 202 and the second end 254 of the second cylinder 204 may be hydraulically connected to the same hydraulic pump 206. In this manner, both cylinders may be substantially simultaneously pressurized at the same time at their respective ends in order to coordinate movement of the ejector plate 104 and the rear gate 110. However, in order to move the rear gate 110 slightly before the ejector plate, the first cylinder 202 may receive back pressure from the first sequence valve 228 being in a closed or locked position. As well, the first sequence valve 228 may be configured to remain hydraulically locked until pressure from the second end 250 of the first cylinder 202 reaches a predetermined pressure. In this manner, the first cylinder 202 is hydraulically locked and unable to move the ejector plate 104 until the predetermined pressure is reached. As such, the rear gate 110 may begin to open before the ejector plate 104 begins to extend. Accordingly, once the predetermined pressure is achieved, the first sequence valve 228 may open, which may hydraulically unlock the first cylinder 202 and thus allow the ejector plate 104 to move to the extended position 108.

As well, because both the first end 248 of the first cylinder 202 and the second end 254 of the second cylinder 204 are hydraulically connected to the same hydraulic pump 206, this may shorten the time to begin moving the ejector plate 104 and the rear gate 110, and it may also increase the moving speed of both the ejector plate 104 and the rear gate 110. When the movement of ejector plate 104 and the rear gate 110 is initiated, excess hydraulic fluid in the second end 250 of the first cylinder 202, may be pumped to the first end 252 of the second cylinder 204, which may effectively regenerate the hydraulic fluid of the system 200. As such, when the movement of the ejector plate 104 and the rear gate 110 is caused, the amount of time between causing this movement and the actual initiation of movement of the ejector plate 104 and the rear gate 110 may be decreased over existing systems. Additionally, the actual moving speed of both the ejector plate 104 and the rear gate 110 may be increased over existing systems. Reducing delay and increasing speed may improve productivity of ejector trucks during operation.

The hydraulic system 200 may also include one or more features to unlock the rear gate 110 in the event that the rear gate 110 becomes hydraulically locked. For example, if the hydraulic pump 206 fails and cannot adequately pressurize the system, then the needle valve 236 may be opened to relieve pressure in the second cylinder 204. The opening of the normally closed needle valve may allow the second cylinder 204 to retract, thereby allowing the rear gate 110 to open.

Some aspects of the hydraulic system 200 may include the accumulator 246, which may at least partially supply additional hydraulic fluid to the first end 252 of the second cylinder 204. Leakage of hydraulic fluid in hydraulic systems may impair performance and damage components. Accordingly, supplying additional hydraulic fluid, via the accumulator 246, to the hydraulic system 200 may result in increased reliability and decreased maintenance.

The disclosure also includes a method of operating the hydraulic system 200 having the ejector plate 104 and the rear gate 110 that are each movably connected to the bed 102. The system includes the first cylinder 202 that is operably connected to the ejector plate 104. The first cylinder 202 has the first end 248 and the second end 250 that are hydraulically connected to ports 216 and 218, respectively. The first cylinder 202 may be configured to move the ejector plate 104 between the retracted position 106 and the extended position 108. The system may also include the second cylinder 204 operably connected to the rear gate 110. The second cylinder 204 may have a first end 252 and a second end 254 that are hydraulically connected to ports 222 and 220, respectively. The second cylinder 204 may be configured to move the rear gate 110 between the closed position 112 and the open position 114. The method may include changing pressure in the first cylinder 202 to extend the ejector plate 104 and changing pressure in the second cylinder 204 to open the rear gate 110. As well, the method may include actuating the sequence valve 228 in response to pressure at port 218 exceeding a predetermined pressure, whereby the pressure may be from the second end 250 of the first cylinder 202. The method may also include supplying the port 215, which may be hydraulically connected to the first end 248 of the first cylinder 202 with hydraulic fluid from the sequence valve 228. It should be appreciated that the predetermined pressure may be 100 bar, or any pressure less than or greater than 100 bar.

In some aspects, the method may include at least partially opening the rear gate 110 before at least partially extending the ejector plate 104. As well, in some aspects, the method may include providing back pressure to port 218, which may be hydraulically connected to the second end 250 of the first cylinder 202. The back pressure may be equal to pressure at port 216, which may be hydraulically connected to the first end 248 of the first cylinder 202. In some aspects, the back pressure may serve to hydraulically lock the pressures at ports 216 and 218, which, in other words, may hydraulically lock the first cylinder 202. As well, in some aspects, the back pressure may be applied to select cylinders within the first cylinder 202. For example, the back pressure may be applied to select smaller cylinders to hydraulically lock them in place, yet allow select larger cylinder to extend. In yet other aspects, the method may include restricting pressure from port 218, which may be hydraulically connected to the second end 250 of the first cylinder 202, to port 216, which may be hydraulically connected to the first end 252 of the second cylinder 204. This restriction may be due to different sizes of first and second cylinders 202, 204 that may be hydraulically connected to ports 216, 218, 220 and 222, and the hydraulic loads that may be applied to each. For example, if the first cylinder 204 is able to withstand greater hydraulic pressure than the second cylinder 204, then the hydraulic pressure at the second cylinder 204 may have to be restricted so as to prevent damage to the second cylinder 204.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A hydraulic system, comprising:
a first cylinder having a first end and a second end, being movable between a retracted position and an extended position;
a second cylinder hydraulically coupled to the first cylinder, the second cylinder having a first end and a second end, and being movable between a retracted position and an extended position;
a hydraulic pump hydraulically coupled to the first cylinder to facilitate its movement to one of its positions, and the second cylinder to facilitate its movement to one of its positions;
a selector valve hydraulically coupled between the first and second ends of the first cylinder, being movable between a first configuration and a second configuration; and
a sequence valve hydraulically coupled downstream of the selector valve, the sequence valve being configured to open when pressure from the second end of the first cylinder reaches a predetermined pressure, wherein, in response to the hydraulic pump providing initial flow to the first end of the first cylinder, the selector valve is in the first configuration to hydraulically couple the second end of the first cylinder to the sequence valve, and when pressure from the second end of the first cylinder reaches the predetermined pressure the sequence valve is moved to permit fluid flow from the second end of the first cylinder to the first end of the first cylinder.

2. The hydraulic system of claim 1, wherein the first cylinder is a multistage cylinder and the second cylinder is a single stage cylinder.

3. The hydraulic system of claim 1, wherein the hydraulic pump is further selectively hydraulically connected to at least the second end of the first cylinder to facilitate its movement to the retracted position, and the first end of the second cylinder to facilitate its movement to the extended position.

4. The hydraulic system of claim 1, wherein when the selector valve is in the second configuration at least the second end of the first cylinder is hydraulically connected to the hydraulic pump to facilitate its movement.

5. The hydraulic system of claim 4, wherein the selector valve is hydraulically actuated and the sequence valve is a relief valve.

6. The hydraulic system of claim 4, wherein the selector valve is spring biased in the first configuration.

7. The hydraulic system of claim 1, further comprising a one-way valve hydraulically connected between the second end of the first cylinder and the first end of the second cylinder.

8. A valve assembly, comprising:
a first ejector port and a second ejector port to be coupled to a corresponding first end and second end of a first cylinder;
a first closure port and a second closure port to be coupled to a corresponding first end and a second end of a second cylinder;
a third port to be coupled to one of a hydraulic pump or a lower pressure tank depending on a position of an implement valve to be coupled, the third port hydraulically coupled to the first ejector port and the second closure port;
a fourth port to be coupled to the other of the hydraulic pump or the lower pressure tank;
a selector valve being movable between a first position and a second position, in the first position, the selector valve is hydraulically coupled between the second ejector port and the third port and the first ejector port, and in the second position, the selector valve is hydraulically coupled between the second ejector port and the fourth port; and
a sequence valve hydraulically coupled between the selector valve, the third port and the first ejector port, wherein, when the selector valve is in the first position, the sequence valve is configured to open when pressure at the second ejector port reaches a predetermined pressure to allow hydraulic fluid to move between the second ejector port and the first ejector port, when the selector valve is in its second position.

9. The valve assembly of claim 8, further comprising a one-way valve hydraulically connected between the second end of the first cylinder and the first end of the second cylinder.

10. The valve assembly of claim 9, further comprising a restriction hydraulically connected between the one-way valve and the first end of the second cylinder.

11. The valve assembly of claim 10, further comprising a load control valve hydraulically connected between the restriction and the first end of the second cylinder, the load control valve including:
a sequence valve, wherein in response to receiving flow from the restriction, the sequence valve is configured to open when pressure from the restriction reaches a predetermined pressure, to permit fluid to flow from the restriction to the tank; and
a one-way valve hydraulically connected in parallel to the sequence valve, wherein the one-way valve is hydraulically connected between the restriction and the tank.

12. The valve assembly of claim 10, further comprising a hydraulic fluid source hydraulically connected between the restriction and the first end of the second cylinder.

13. The valve assembly of claim 8, further comprising a second sequence valve hydraulically connected to the second end of the first cylinder, the second sequence valve configured to open when pressure from the second end of the first cylinder reaches a predetermined pressure to permit fluid to flow from the second end of the first cylinder to the tank.

14. A truck, comprising:
a bed;
an ejector plate coupled to the bed, the ejector plate being movable between a retracted position, such that the bed is able to receive load material, and an extended position, such that the load material is at least partially removed from the bed;
a rear gate coupled to the bed, the rear gate being movable between a closed position thereby retaining the load material in the bed, and an open position thereby allowing at least a portion of the load material to be removed from the bed;
a first cylinder operably connected to the ejector plate, the first cylinder having a second end and a first end, and being movable between a retracted position and an extended position, the first cylinder configured to move the ejector plate between the retracted and extended positions;
a second cylinder operably connected to the rear gate and hydraulically connected to the first cylinder, the second cylinder having a second end and a first end, and being movable between a retracted position and an extended position, the second cylinder configured to move the rear gate between the closed and open positions;
a hydraulic pump coupled to the first and second cylinders;
a selector valve hydraulically connected to the second end of the first cylinder, being movable between a first configuration and a second configuration; and
a sequence valve hydraulically connected between the selector valve and the first end of the first cylinder, wherein, in response to the hydraulic pump providing initial flow to the first end of the first cylinder to move the first cylinder to the extended position, the selector valve is in the first configuration to hydraulically couple the second end of the first cylinder to the sequence valve, and the sequence valve is configured to open when pressure from the second end of the first cylinder reaches a predetermined pressure, to permit fluid to flow from the second end of the first cylinder to the first end of the first cylinder.

15. The truck of claim 14, further comprising an implement valve being movable between a 1) first configuration, whereby a first port of the implement valve is hydraulically connected between hydraulic pump and the first end of the first cylinder, 2) a second configuration, whereby a first port of the implement valve is hydraulically connected between the hydraulic pump and the selector valve, and 3) a third configuration, whereby a first port of the implement valve is hydraulically connected to the hydraulic pump and a closed path.

16. The truck of claim 15, wherein when the implement valve is in the first configuration, a second port of the implement valve is hydraulically connected between the selector valve and a hydraulic fluid tank.

17. The truck of claim 15, wherein when the implement valve is in the second configuration, a third port of the implement valve is hydraulically connected between the first end of the first cylinder and a hydraulic fluid tank.

18. The truck of claim 15, wherein when the implement valve is in the third configuration, at least the first end of the first cylinder and the selector valve are hydraulically connected to respective closed paths.

19. The truck of claim 18, wherein when the selector valve is in the first configuration at least the second end of the first cylinder is hydraulically connected to the sequence valve.

20. The truck of claim 19, wherein when the selector valve is in the first configuration the sequence valve is configured to open when pressure from the second end of the first cylinder reaches a predetermined pressure to provide hydraulic fluid to the first end of the first cylinder.
